(19) United States
(12) Patent Application Publication
(10) Pub. No.: US 2003/0011190 A1
(43) Pub. Date: Jan. 16, 2003

(54) Wrist notepad holder

(76) Inventor: Robert T. Ryan, Avila Beach, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/177,264

(22) Filed: Jun. 21, 2002

Related U.S. Application Data
(60) Provisional application No. 60/299,933, filed on Jun. 21, 2001.

(51) Int. Cl. B42D 5/00

(52) U.S. Cl. 281/45; 281/15.1; 281/51

(57) ABSTRACT

A lightweight molded notepad holder that straps to the users wrist. The holder uses commercially available self-stick notes that insert directly into the holder. The individual pages of the notepad may be prevented from flying up or curling by use of one or more retainers built into the corners of the holder. Once in the holder, the pages are instantly available for note taking or dispensing as self-stick notes. The wrist strap also accommodates a wristwatch in conjunction with the wrist notepad holder.

### RELATED APPLICATION

This application claims the benefit of U.S. Provisional Patent Application No. 60/299,933 filed on Jun. 21, 2001 (Attorney Docket No. 005702P001Z).

### BACKGROUND OF THE INVENTION

1. Field of the Invention

The present invention relates to the field of wrist mounted note taking devices.

2. Prior Art

Prior art wrist mounted notepads require the user to either use a slate with special writing instrument, or a continuous scroll of specialized paper, or individual sheets of specialized paper held in place by various mechanical devices. Such prior art devices include those disclosed by Weiss, U.S. Pat. No. 1,407,239, Zelenko, U.S. Pat. No.4,083,136, Rankin, U.S. Pat. No.4,824,140, Schreindl, U.S. Pat. No. 4,906,025, Wiltshire, U.S. Pat. No.5,531,481, Zipoy U.S. Pat. No.1,419,190, and Canfield U.S. Pat. No. 2,099,295.

Most devices in prior art have a tendency to be too specialized for general use, particularly when one considers that the self stick notepad concept is now so universal. Also many devices in the prior art are cumbersome in design, incorporating detachable parts and assemblies susceptible to loss or damage. Nearly all devices utilize a specialized note material or note size not otherwise commercially available. The present invention, using commercially available notepads in a simple, one piece holder, provides an efficient device to a universal-market.

### BRIEF SUMMARY OF THE INVENTION

A lightweight molded notepad holder that straps to the users wrist. The holder uses commercially available self-stick notes that insert directly into the holder. The individual pages of the notepad may be prevented from flying up or curling by use of one or more retainers built into the corners of the holder. Once in the holder, the pages are instantly available for note taking or dispensing as self-stick notes. The wrist strap also accommodates a wristwatch in conjunction with the notepad holder.

Accordingly, the objects of the invention include, but are not limited to:

1. providing a simple, economical device for holding a notepad on the wrist; and,

2. providing a notepad holder that accommodates commercially available replacement notepads.

Other objects and advantages include:

1. the convenience of using a self-stick note;

2. the use of replacement notepads that are available at most stationary and convenience stores;

3. a simple, molded one-piece holder without removable components that may get lost or broken;

4. an ergonomic design offering stability and comfort while worn on the wrist;

5. built-in page retainers to prevent the top pages of the notepad from flying up or curling when in the holder;

6. a contoured shape of the holder that allows the user to wear it under clothing like a jacket without it snagging or catching on the clothing; and,

7. an adjustable strap design that allows a wristwatch to be attached in conjunction with the Wrist Writer

Further objects and advantages of my invention will become apparent from a consideration of the drawings and ensuing description.

### BRIEF DESCRIPTION OF THE DRAWINGS

FIG. 1 is a perspective view of a preferred embodiment of the present invention.

FIG. 2 is a top view of the exemplary wrist notepad holder of the present invention.

FIG. 3 is an end view of the exemplary wrist notepad holder of the present invention.

FIG. 4 is a first side view of the exemplary wrist notepad holder of the present invention.

FIG. 5 is a bottom view of the exemplary wrist notepad holder of the present invention.

FIG. 6 is a second side view of the exemplary wrist notepad holder of the present invention.

FIG. 7 is a cross section taken through one of the page retaining members of the exemplary notepad holder of the present invention.

FIG. 8 is an end view illustrating the further mounting of a watch on the wrist notepad holder wristband of the present invention.

### DETAILED DESCRIPTION OF THE PREFERRED EMBODIMENT

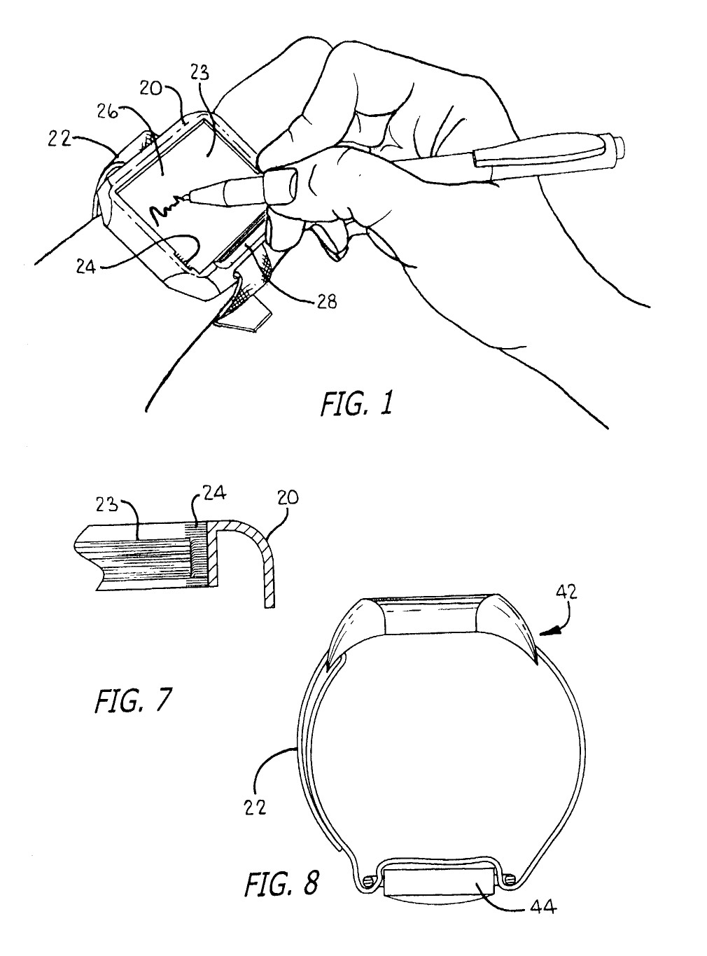

First referring to FIG. 1, a perspective view of a preferred embodiment of the present invention, as the same may be used, may be seen. The wrist pad holder is comprised of a body member 20 and a wrist strap 22. Mounted within the body member is a conventional self-stick removable notepad 23 the type widely commercially available and sold under various trademarks, such as the registered trademark “POST-IT”. The particular embodiment shown is sized and proportioned to receive a 1″ by 1.5″ notepad, though the invention could be sized to receive larger notepads if desired. Also visible in FIG. 1 is a page retaining member 24, the view of a second page retaining member being obstructed by the depiction of a user's hand and pen. Worn in this way, adhesive edge 26 of the notepad would be positioned opposite the page retaining members 24 so that the page retaining members 24 prevent the free edges of the notepad pages from curling up, getting caught on sleeves, etc. For removal of a notepad page, body member 20 includes a depression 28 opposite the adhesive edge 26 to allow one to get under the top notepad page for removal of that page from the notepad. In that regard, obviously the wrist notepad holder may be rotated 180° with respect to the user's arm so that the page removal depression 28 is on the opposite side of the wrist notepad holder if the user finds that more convenient. Further, while FIG. 1 suggests that the wrist notepad holder be positioned to hold the notepad on the top of the wrist, the same may be positioned under the wrist if the user finds that more convenient or comfortable in use.

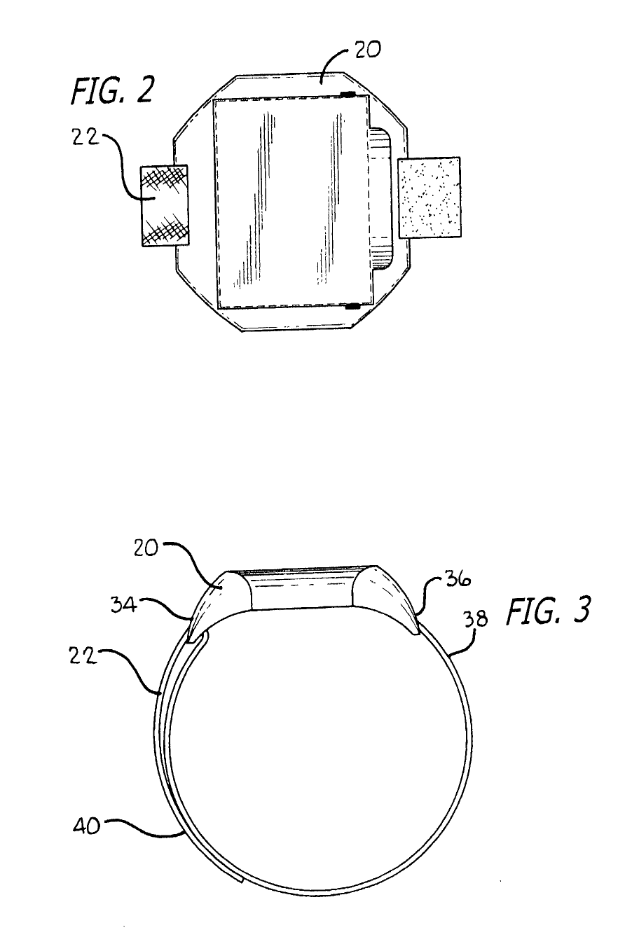

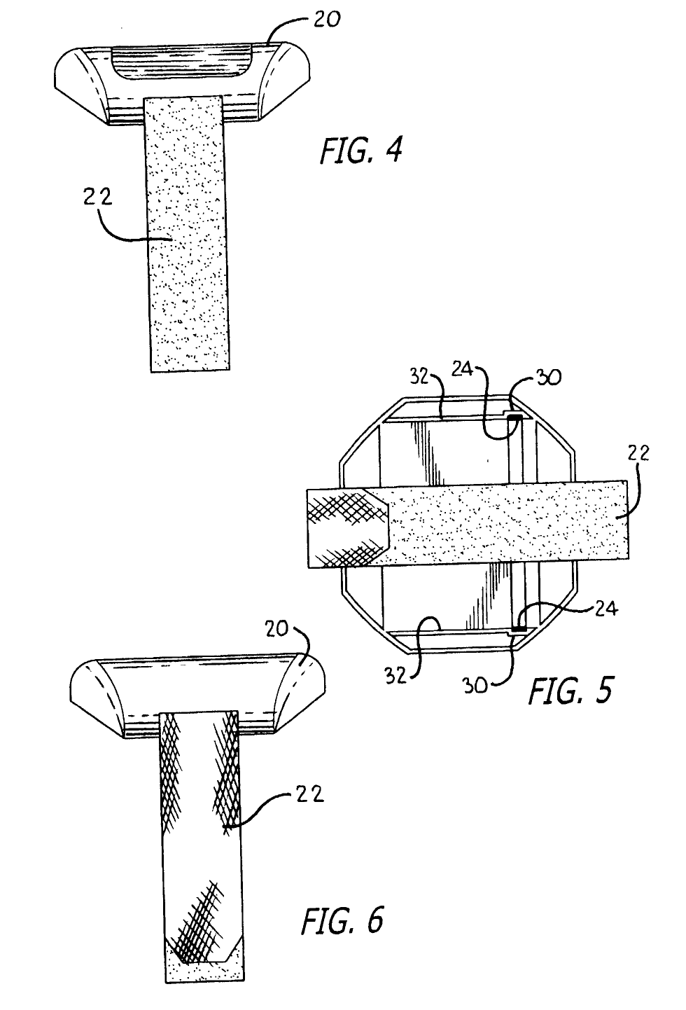

FIGS. 2, 3, 4, 5 and 6 present a top view, an end view, a first side view, a bottom view, and a second side view, and respectively, of the exemplary embodiment of wrist notepad holder of the present invention. As may be seen in these Figures, the wrist notepad holder is contoured to fit comfortably on a user's wrist with a contoured exterior shape to allow the user to wear it under clothing, such as a long sleeved shirt or jacket without snagging or catching on the clothing. The depression or pocket for receiving the notepad may be of sufficient depth so that the top page of the notepad is substantially level with or even slightly below the adjacent exterior surface of the wrist notepad holder further reduce the tendency of pages to snag on clothing, to lift up, or become frayed.

FIG. 7 presents a cross section taken through one of the page retaining members 24. As may be seen in FIG. 5, the page retaining members 24 fit within depressions 30 in internal walls 32 so as to engage the respective edges of the notepad 23 in the wrist notepad holder. The page retaining members 24 in the preferred embodiment are pieces of hook material of the well-known and readily commercially available hook and loop type fasteners, such as, by way of example, are sold under the registered trademark “VELCRO”. The page retaining members 24 resist lifting of the edges of the notepad 23, though do not interfere with the intentional removal of each page of the notepad when desired.

Now referring to FIG. 3 again, it may be seen that the wristband 22 in the preferred embodiment is a single band passing through a slot in the lower edge 34 of the body 20. The opposite edge 36 of the body 20 has a similar slot, with the wristband 22 also passing there through. In that regard, the inner end of the wristband adjacent region 38 preferably has an enlarged end to keep that end of the wristband from passing through that slot. In a preferred embodiment, the wristband as shown in FIG. 3 is a single band having hook and loop fastener material on adjacent surfaces o-f the wristband in region 40 so that the wristband is fully adjustable and readily releasable for the convenience of the user.

In addition, the wristband may also accommodate a watch as shown in FIG. 8. In particular, the wrist notepad holder, generally indicated by the numeral 42, may be positioned to rest on one side of the user's wrist with a watch 44 supported by the same wristband on the other side of the user's wrist if desired.

As may be seen from the foregoing disclosure, the wrist notepad holder of the exemplary embodiment is a simple light weight and low cost device comprised of two principal parts, namely the body 20 and the wristband 22. The body 20 is preferably injection molded of a semi-rigid or rigid plastic. As suggested in FIG. 7, the walls of the body 20 are preferably generally of uniform thickness, providing the desired shape and structural integrity while minimizing the weight of the device.

While a preferred embodiment of the present invention and certain variations thereof have been disclosed herein, such disclosure is only for purposes of understanding the exemplary embodiment and not by way of limitation of the invention. It will be obvious to those skilled in the art that various changes in form and detail may be made in the invention without departing from the spirit and scope of the invention as set out in the full scope of the following claims.

What is claimed is:

1. A device for use in taking notes comprising:
a body member having a depression therein sized to receive a pad of paper characterized by a stack of individual sheets, each having an adhesive adjacent an edge of one side one side thereof holding the pad together, and capable of holding each sheet to another object when removed from the pad; and
a adjustable wristband coupled to opposite edges of the device.

2. The device of claim 1 wherein the body member has a depression therein sized to receive a predetermined size of Post-it® type pad.

3. The device of claim 1 wherein the adjustable wristband is comprised of first and second band members, each coupled to a respective opposite edge of the body member, one of the band members having a loop member coupled thereto and the other band member having a hook member coupled thereto, the adjustability of the wristband being provided by the variability of the engagement of the hook and loop members.

4. The device of claim 3 wherein the hook and loop members are Velcro® members.

5. The device of claim 1 further comprised of a hold-down member coupled to the body member to engage a pad of paper therein away from the edge having the adhesive thereon to help prevent fraying of the edges of the pad not held together by the adhesive.

6. The device of claim 5 wherein the hold-down member is a piece of hook material disposed with the hooks thereon directed to contact an edge of a pad of paper in the body member.

7. The device of claim 1 wherein the body member is a plastic body member having a substantially uniform thickness.

8. A device for use in taking notes comprising:
a body member having a depression therein sized to receive a Post-it® pad; and
a adjustable wristband coupled to opposite edges of the device and having a Velcro® type adjustable closure.

9. The device of claim 8 further comprised of a hold-down member coupled to the body member to engage a pad of paper therein away from the edge having the adhesive thereon to help prevent fraying of the edges of the pad not held together by the adhesive.

10. The device of claim 9 wherein the hold-down member is a piece of hook material disposed with the hooks thereon directed to contact an edge of a pad of paper in the body member.

11. The device of claim 1 wherein the body member is a plastic body member having a substantially uniform thickness.

12. The device of claim 1 wherein the adjustable wristband is configured to also couple a wristwatch to a user's wrist.

13. A wrist mounted notepad holder comprising a frame of substantially rigid material having a base, end walls, back wall and a front wall of sufficient dimension to accommodate a predetermined size note pad consisting of a plurality of individual pages disposed in stacked superimposed relation and held in abutting relation to said walls, with inwardly extending projections carried by certain of said walls to engage said pages.

14. The ornamental design for a wrist notepad holder as shown and described.
